(19) United States
(12) Patent Application Publication
(10) Pub. No.: US 2008/0316875 A1
(43) Pub. Date: Dec. 25, 2008

(54) Optical Disc Apparatus for Accessing a Plurality of Optical Discs and Operating Method thereof

(76) Inventor: Kun-Yi Chan, Changhua County (TW)

Correspondence Address: NORTH AMERICA INTELLECTUAL PROPERTY CORPORATION, P.O. BOX 506, MERRIFIELD, VA, 22116, US

(21) Appl. No.: 11/767,529

(22) Filed: Jun. 25, 2007

(51) Int. Cl. G11B 7/00

(52) U.S. Cl. 369/44.11

(57) ABSTRACT

The present invention discloses an optical disc apparatus. The optical disc apparatus includes a rotation module for rotating a plurality of optical discs; a plurality of holding plates, which at least includes a first holding plate and a second holding plate, for loading the optical discs; a sled guide bar positioned between the first holding plate and second holding plate on a straight line; an optical pick-up unit for accessing the optical discs; and a sled motor, moveably positioned of sled on the sled guide bar, for loading the optical pick-up unit and driving the optical pick-up unit along the sled guide bar to access each of the optical discs loaded on the holding plates.

### BACKGROUND OF THE INVENTION

The present invention relates to optical disc apparatus and operating method thereof, and more particularly, to an optical disc apparatus that is able to access at least two optical discs simultaneously by using one optical pick-up unit and operating method thereof.

The DVR (digital video recorder) is one of the most popular electronic devices nowadays. There are typically two types of DVRs. The first type of DVR is one with a recordable DVR that can record and play multimedia data. The second type of DVR is a recordable DVR with an additional hard disc drive for data storage whenever the recordable DVR is recording or playing multimedia data. The configuration of the first-type recordable DVR is composed of an optical pick-up unit, a holding plate, a tray, a spindle, and a sled. Therefore, according to the configuration of the first-type of recordable DVR, the first-type recordable DVR is just capable of being able to load only one optical disc, and then record data to or play data from that one optical disc, i.e., one optical disc at a time (i.e., simultaneously). This is quite inconvenient for users that require playing and recording multimedia data at the same time.

On the other hand, the configuration of the second-type of recordable DVR is substantially the same as the first-type recordable DVR except the additional hard disc drive. When the second-type recordable DVR is playing a multimedia data, the additional hard disc drive is able to provide the multimedia data at the same time; or when the second type recordable DVR is recording a multimedia data, the additional hard disc drive is able to store the multimedia data at the same time. Although the second-type recordable DVR is able to play and record simultaneously with the help of the additional hard disc drive, the additional hard disc, however, will increase the cost of the second-type recordable DVR. Furthermore, the controlling of the second-type recordable DVR is typically through a user interface (UI) that is somehow not convenient to some users.

### SUMMARY OF THE INVENTION

According to exemplary embodiments of the present invention, an optical disc apparatus is provided. The optical disc apparatus includes: a rotation module for rotating a plurality of optical discs; a plurality of holding plates, at least comprising a first holding plate and a second holding plate, for loading the optical discs; a sled guide bar, positioned between the first holding plate and second holding plate on a straight line; an optical pick-up unit, for accessing the optical discs; and a sled motor, moveably positioned of sled on the sled guide bar, for loading the optical pick-up unit and driving the optical pick-up unit along the sled guide bar to access each of the optical discs loaded on the holding plates.

According to exemplary embodiments of the present invention, a method for operating an optical disc apparatus is also provided. The method includes: starting up a first optical disc, restoring a first interface and servo relation parameters of the first optical disc into a buffer; performing a DMO (Driver Motor Output) Hold operation or open loop DAC operation for the first optical disc; starting up a second optical disc; restoring a second interface and servo relation parameters of the second disc into the buffer; and performing the DMO Hold operation on a second spindle driver.

According to exemplary embodiments of the present invention, another method for operating an optical disc apparatus is provided. The method includes: receiving an interface command for accessing a first optical disc when accessing the second optical disc; performing the DMO Hold operation or open loop DAC operation for the second optical disc; switching to accessing the first optical disk; reloading a first interface and servo relation parameters of the first optical disc from the buffer, and accessing the first optical disc.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an optical disc apparatus according to an embodiment of the present invention.

FIG. 2 is a flowchart of a method for operating the optical disc apparatus shown in FIG. 1.

FIG. 3 is a diagram illustrating single-work operation performed by the optical disc apparatus shown in FIG. 1.

FIG. 4 is a flowchart illustrating switching data access between two optical discs according to an embodiment of the present invention.

FIG. 5 is a diagram illustrating multi-work operation performed by the optical disc apparatus shown in FIG. 1.

FIG. 6 is a diagram illustrating the optical disc apparatus according to another embodiment of the present invention.

FIG. 7 is a side-view of the optical disc apparatus shown in FIG. 6.

FIG. 8 illustrates a flowchart of a method for operating the optical disc apparatus shown in FIG. 6.

FIG. 9 is a flowchart of the method for switching data access between the first DVD disc and the second DVD disc shown in FIG. 6.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

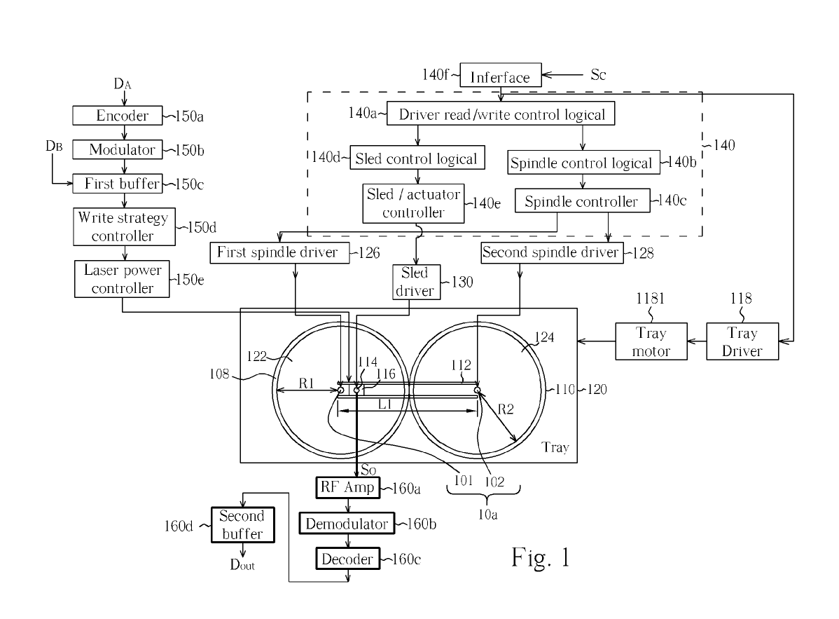

Please refer to FIG. 1. FIG. 1 is a diagram illustrating an optical disc apparatus 100 according to an embodiment of the present invention. Optical disc apparatus 100 comprises a rotation module 10a having a first spindle motor 101 and a second spindle motor 102, a first holding plate 108, a second holding plate 110, a sled guide bar 112, an optical pick-up unit 114, a sled motor 116, and a tray motor 1181. The first spindle motor 101 and second spindle motor 102 are used for rotating a first optical disc 122 and a second optical disc 124 through the controlling of the first spindle 101 and the second spindle 102, respectively; the first holding plate 108 and second holding plate 110 are used for loading the first and second optical discs 122 and 124; the sled guide bar 112 is positioned between the first holding plate 108 and second holding plate 110 on a straight line; the optical pick-up unit 114 is for accessing the first and second optical discs 122 and 124, selectively; the sled motor 116 is moveably positioned of sled on the sled guide bar 112 for loading the optical pick-up unit 114 and driving the optical pick-up unit 114 along the sled guide bar 112 to access each of the first and second optical discs 122, 124 loaded on respective holding plates 108, 110; and the tray motor 1181 is coupled to a tray 120 for moving the tray 120 to load the first and second optical discs 122, 124 into the optical disc apparatus 100 or to eject the first and second optical discs 122, 124 from the optical disc apparatus 100. As one can see, the holding plates 108, 110 are placed on tray 120.

According to the embodiment of optical disc apparatus 100, the first spindle motor 101 and second spindle motor 102 are driven by a first spindle driver 126 and a second spindle driver 128, respectively. The tray motor 1181 is driven by a tray driver 118. The sled motor 116 moves the optical pick-up unit 114 along the length L1 of the sled guide bar 112 in order to access the entire area of the first DVD disc 122 and the second DVD disc 124. The sled motor 116 is driven by a sled driver 130. As shown in FIG. 1, the first spindle driver 126, the second spindle driver 128, the tray driver 118, and the sled driver 130 are controlled by a servo controller 140. The servo controller 140 is coupled to the first spindle driver 126 and second spindle driver 128, for performing a DMO (Driver Motor Output) Hold operation or open loop DAC operation for the first spindle motor 101 rotating the first optical disc 122 before the sled motor 116 moves the optical pick-up unit 114 from the first optical disc 122 to the second optical disc 124 and vice-versa. The servo controller 140 comprises a driver read/write control logical 140a, a spindle control logical 140b, a spindle controller 140c, a sled control logical 140d, and a sled/actuator controller 140e. In addition, the servo controller 140 is coupled to an interface 140f and implemented to receive a control signal S_{c} from a computer system. The driver read/write control logical 140a receives the control signal S_{c} to determine the reading or the writing operation of the first optical disc 122 and the second optical disc 124. The spindle control logical 140b is coupled to the driver read/write control logical 140a and implemented to indicate the spindle controller 140c for controlling one of the first spindle motor 101 and the second spindle motor 102. On the other hand, the sled control logical 140d is also coupled to the driver read/write control logical 140a and implemented to indicate the sled/actuator controller 140e for controlling the sled motor 116.

Furthermore, it should be noted that the input data can be categorized into two types, i.e., the data D_{A} and D_{B}. The first type of data D_{A} needs to be encoded before writing into the first optical disc 122 and the second optical disc 124, and the second type of data D_{B} does not need to be encoded before writing into the first optical disc 122 and the second optical disc 124. Therefore, please refer to FIG. 1 again, the first type of data D_{A} is encoded by an encoder 150a and a modulator 150b, however the second type of data D_{B} is directly inputted to a first buffer 150c. Then, the first type of data D_{A} and the second type of data D_{B} can be written into the first optical disc 122 and the second optical disc 124 through the utilization of a write strategy controller 150d and a laser power controller 150e. Please note that, those skilled in this art are readily to know the operations of the encoder 150a, modulator 150b, first buffer 150c, write strategy controller 150d, and laser power controller 150e, thus the detailed description is omitted here for brevity. In addition, as known by those skilled in this art, when a data signal Sₒ is read from the first optical disc 122 or the second optical disc 124 by the optical pick-up unit 114, the data signal Sₒ is passed through an RF amplifier 160a, a demodulator 160b, a decoder 160c, and a second buffer 160d for generating an output data Dₒᵤₜ, and the operation is omitted here for brevity.

To better understand the operation of the present invention optical disc apparatus 100, please consider the following example. The first optical disc 122 can be a DVD disc (the first optical disc 122 is called as first DVD disc hereinafter) and the second optical disc 124 can be a DVD disc (the second optical disc 124 is called as second DVD disc hereinafter), and are loaded into the first holding plate 108 and second holding plate 110 respectively for convenience. Please note that, the user is allowed to load any kinds of optical discs supported by the optical disc apparatus 100 into the first holding plate 108 and second holding plate 110, such as VCD discs. In addition, the present invention is not limited to load discs of the same disc type into the first holding plate 108 and second holding plate 110.

According to the embodiment of optical disc apparatus 100, the first spindle motor 101 and second spindle motor 102 are driven by a first spindle driver 126 and a second spindle driver 128, respectively. Accordingly, the sled motor 116 is able to move the optical pick-up unit 114 along the length L1 of the sled guide bar 112 in order to access the entire area of the first DVD disc 122 and the second DVD disc 124. The sled motor 116 is driven by a sled driver 130. As shown in FIG. 1, the first spindle driver 126, the second spindle driver 128, and the sled driver 130 are controlled by the servo controller 140 through any well-known servo mechanism.

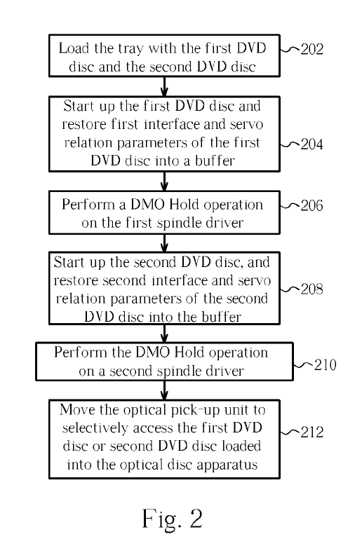

Please refer to FIG. 2. FIG. 2 illustrates a flowchart of a method for operating the optical disc apparatus 100 shown in FIG. 1 according to an embodiment of the present invention. The method comprises the steps below:
Step 202: Load the tray 120 with the first DVD disc 122 and the second DVD disc 124 loaded on the first holding plate 108 and the second holding plate 110 respectively, into the optical disc apparatus 100;
Step 204: Start up the first DVD disc 122 and restore first interface and servo relation parameters of the first DVD disc 122 into a buffer;
Step 206: Perform a DMO (Driver Motor Output) Hold operation on the first spindle driver 126;
Step 208: Start up the second DVD disc 124, and restore the second interface and servo relation parameters of the second DVD disc 124 into the buffer;
Step 210: Perform the DMO Hold operation on a second spindle driver 128; and
Step 212: Move the optical pick-up unit 114 to selectively access the first DVD disc 122 or second DVD disc 124 loaded into the optical disc apparatus 100.

In steps 204 to 210, the method performs a start-up operation for initialization of the optical disc apparatus 100. When the tray 120 moves to carry the first holding plate 108 and second holding plate 110 with the first DVD disc 122 and second DVD disc 124 loaded thereon into the optical disc apparatus 100, the servo controller 140 starts up the first spindle driver 126 and restores the first interface and servo relation parameters of the first spindle driver 126 into servo controller 140 to perform a DMO (Driver Motor Output) Hold operation or open loop DAC operation on the first spindle driver 126. Then, the servo controller 140 starts up the second spindle driver 128 and restores the second interface and servo relation parameters of the second spindle driver 128 into the servo controller 140 to perform the DMO Hold operation or open loop DAC operation on the second spindle driver 128 to complete the start-up operation.

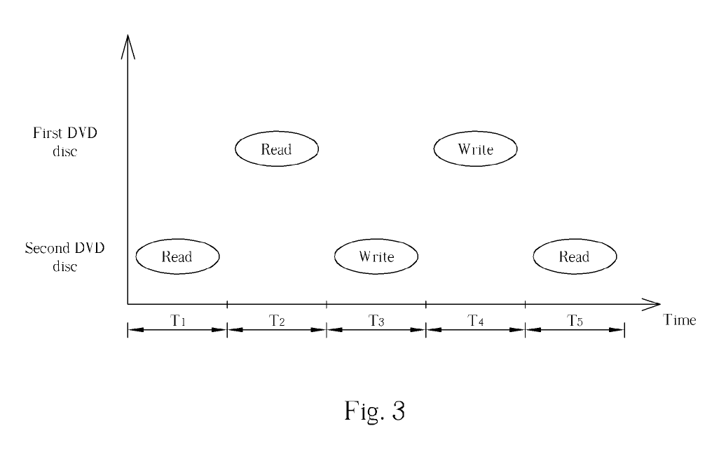

After the initialization (i.e., the start-up operation), in step 212, the optical disc apparatus 100 is allowed to execute a variety of data accessing operations through moving optical pick-up unit 114 between the first DVD disc 122 and the second DVD disc 124 and switching between the first spindle driver 126 and the second spindle driver 128. Normally, there have two major accessing operations in optical disc apparatus 100 of the present invention in step 212. The first is a single-work operation and the second is a multi-work operation. Please refer to FIG. 3. FIG. 3 illustrates a timing diagram of the single-work operation performed by the optical disc apparatus 100 shown in FIG. 1. As shown in FIG. 3, the optical disc apparatus 100 reads the second DVD disc 122 during time interval T₁, and reads the first DVD disc 124 during time interval T₂. In other words, during a period including time intervals T₁, T₂, the servo controller 140 first controls the second spindle driver 128 to drive the second spindle motor 102 during time interval T₁, and at the same time the optical pick-up unit 114 reads the second DVD disc 124 continuously. After the read operation of the second DVD disc 124 is completed at the end of time interval T₁, the optical pick-up unit 114 is moved to the first DVD disc 122 by the sled motor 116 for accessing the first DVD disc 122, and the servo controller 140 switches from the second spindle driver 128 to the first spindle driver 126 to drive the first spindle motor 101 during time interval T₂. At the same time, the optical pick-up unit 114 reads the first DVD disc 122 continuously until the read operation is completed at the end of time interval T₂.

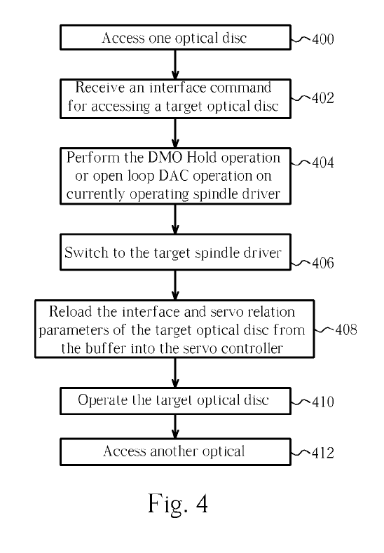

Please refer to FIG. 4. FIG. 4 is a flowchart illustrating switching data access between the first DVD disc 122 and the second DVD disc 124 according to an embodiment of the present invention. The operation of switching between the first DVD disc 122 and the second DVD disc 124 is summarized as follows:
Step 400: Access one optical disc (e.g., the second DVD disc 124);
Step 402: Receive an interface command for accessing a target optical disc (e.g., the first DVD disc 122), where the other optical disc (e.g., the second DVD disc 124) is currently in operation;
Step 404: Perform the DMO Hold operation or open loop DAC operation on currently operating spindle driver (e.g., the second spindle driver 128);
Step 406: Switch to the target spindle driver (e.g., the first spindle driver 126);
Step 408: Reload the interface and servo relation parameters of the target optical disc (e.g., the first DVD disc 122) from the buffer into the servo controller 140;
Step 410: Operate the target optical disc (e.g., the first DVD disc 122) according to the reloaded interface and servo relation parameters; and
Step 412: Access another optical disc (e.g., the first DVD disc 122).

Please note that, the single-work operation of the optical disc apparatus 100 of the present invention is not limited to a combination of read operations, and all other combinations of read/write operation(s) are possible. As shown in FIG. 3, during a period including time intervals T₂, T₃, a combination of read and write operations is activated, where the optical pick-up unit 114 reads the first DVD disc 122 first, and then writes the second DVD disc 124; during a period including time intervals T₃, T₄, a combination of write operations is activated, where the optical pick-up unit 114 writes the second DVD disc 124 first, and then writes the first DVD disc 122; and during a period including time intervals T₄, T₅, a combination of write and read operations is activated, where the optical pick-up unit 114 writes the first DVD disc 122 first, and then reads the second DVD disc 124.

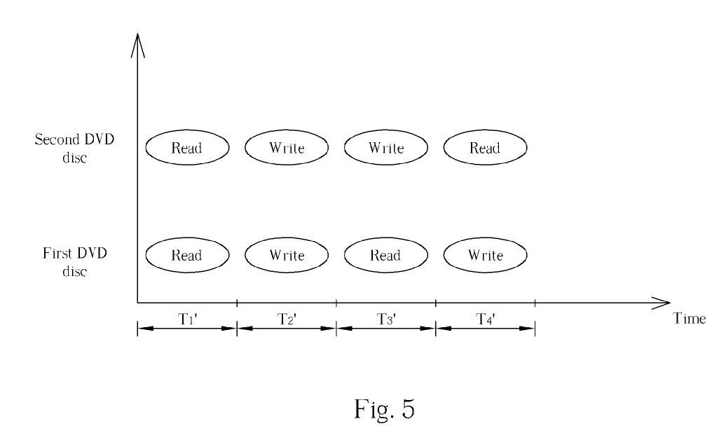

Please refer to FIG. 5. FIG. 5 illustrates a diagram of the multi-work operation performed by the optical disc apparatus 100 shown in FIG. 1. As shown in FIG. 5, the optical disc apparatus 100 reads the first DVD disc 122 and the second DVD disc 124 during time interval T₁′ by switching between the first DVD disc 122 and the second DVD disc 124 according to the flow shown in FIG. 4. Similarly, please note that, the multi-work operation of the optical disc apparatus 100 of the present invention is not limited to a combination of read operations, and all other combinations of read/write operation(s) are possible. As shown in FIG. 4, during a time intervals T₂′, a combination of write operations is activated, where the optical pick-up unit 114 write the first DVD disc 122 first and the second DVD disc 124 alternately (i.e., is an alternating fashion); during a time intervals T₃′, a combination of write and read operations is activated, where the optical pick-up unit 114 writes the first DVD disc 122 and reads the second DVD disc 124 alternately; and during a time intervals T₄′, a combination of read operation and write operations is activated, where the optical pick-up unit 114 reads the first DVD disc 122 and writes the second DVD disc 124 alternately.

In the above disclosed embodiment, a single optical pick-up unit 114 is moved on the sled guide bar 112 to access two loaded optical discs 122 and 124. However, the present invention is not limited to the number of optical discs loaded to the optical disc apparatus. For example, in other embodiments, a single optical pick-up unit is moved on the sled guide bar to access a plurality of loaded optical discs (e.g., three optical discs), which still obeys the spirit of the present invention and falls in the scope of the present invention.

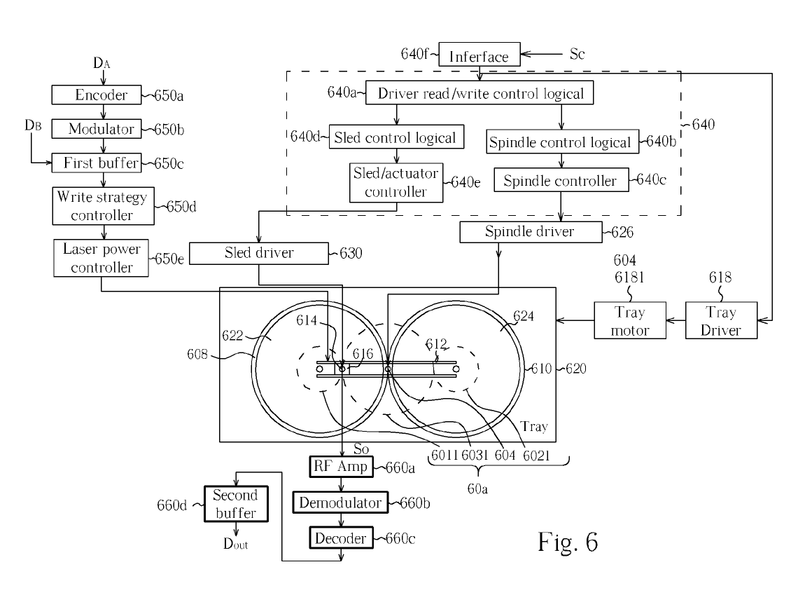

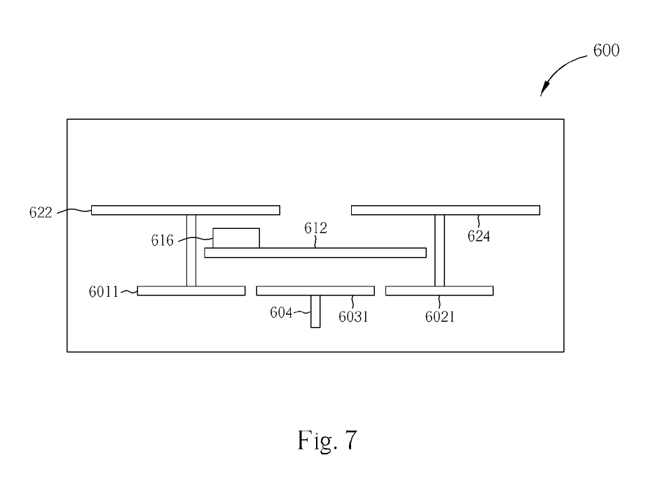

Please refer to FIG. 6. FIG. 6 is a diagram illustrating an optical disc apparatus 600 according to another embodiment of the present invention. The optical disc apparatus 600 comprises a first holding plate 608, a second holding plate 610, a sled guide bar 612, an optical pick-up unit 614, a sled motor 616, a tray motor 6181, and a rotation module 60a having a main spindle motor 604, a first transmission mechanism 6011, a second transmission mechanism 6021, and a third transmission mechanism 6031 coupled to the first transmission mechanism 6011 and the second transmission mechanism 6021 as shown in FIG. 6. Please refer to FIG. 7. FIG. 7 is a side-view of the optical disc apparatus 600 shown in FIG. 6. In this embodiment, the main spindle motor 604 is coupled to the third transmission mechanism 6031 for rotating the third transmission mechanism 6031. Then, the first transmission mechanism 6011 and the second transmission mechanism 6021 are driven by the third transmission mechanism 6031. Accordingly, a first DVD disc 622 and a second DVD disc 624 are rotated by the first transmission mechanism 6011 and the second transmission mechanism 6021, respectively. The first holding plate 608 and second holding plate 610 are used for loading the first and second DVD discs 622 and 624; the sled guide bar 612 is positioned between the first holding plate 608 and second holding plate 610 on a straight line; the optical pick-up unit 614 is for accessing the first and second DVD discs 622 and 624, selectively; the sled motor 616 is moveably positioned of sled on the sled guide bar 612 for loading the optical pick-up unit 614 and driving the optical pick-up unit 614 along sled guide bar 612 to access each of the first and second DVD discs 622, 624 loaded on respective holding plates 608, 610; and the tray motor 6181 is coupled to a tray 620, for moving tray 620 to load the first and second DVD discs 622, 624 into optical disc apparatus 600 or to eject the first and second DVD discs 622, 624 from optical disc apparatus 600. In this embodiment, the tray motor 6181 is controlled by a tray driver 618 as shown in FIG. 6. As one can see, the holding plates 608, 610 are placed on the tray 620. Furthermore, the optical disc apparatus 600 further comprises a servo controller 640, coupled to the main spindle motor 604, for performing a DMO (Driver Motor Output) Hold operation or open loop DAC operation for the third transmission mechanism 6031 rotating the first DVD disc 622 before the sled motor 616 moves the optical pick-up unit 614 from the first DVD disc 622 to the second DVD disc 624 and vice-versa. The servo controller 640 comprises a driver read/write control logical 640a, a spindle control logical 640b, a spindle controller 640c, a sled control logical 640d, and a sled/actuator controller 640e. In addition, the servo controller 640 is coupled to an interface 640f and implemented to receive a control signal S_{c} from a computer system. The driver read/write control logical 640a receives the control signal S_{c} to determine the reading or the writing operation of the first optical disc 622 and the second optical disc 624. The spindle control logical 640b is coupled to the driver read/write control logical 640a and implemented to indicate the spindle controller 640c for controlling the third transmission mechanism 6031. On the other hand, the sled control logical 640d is also coupled to the driver read/write control logical 640a and configured to indicate the sled/actuator controller 640e for controlling the sled motor 616. Furthermore, it should be noted that the input data can be categorized into two types, i.e, the data D_{A} and D_{B}. The first type of data D_{A} needs to be encoded before writing into the first optical disc 622 and the second optical disc 624, and the second type of data D_{B} does not need to be encoded before writing into the first optical disc 622 and the second optical disc 624. Therefore, please refer to FIG. 1 again, the first type of data D_{A} is encoded by an encoder 650a and a modulator 650b, however the second type of data D_{B} is directly inputted to a first buffer 650c. Then, the first type of data D_{A} and the second type of data D_{B} can be written into the first optical disc 622 and the second optical disc 624 through the utilization of a write strategy controller 650d and a laser power controller 650e. Please note that, those skilled in this art are readily to know the operations of the encoder 650a, modulator 650b, first buffer 650c, write strategy controller 650d, and laser power controller 650e, thus the detailed description is omitted here for brevity. In addition, as known by those skilled in this art, when a data signal Sₒ is read from the first optical disc 622 or the second optical disc 624 by the optical pick-up unit 614, the data signal Sₒ is passed through a RF amplifier 660a, a demodulator 660b, a decoder 660c, and a second buffer 660d for generating an output data Dₒᵤₜ, and the operation is omitted here for brevity. Please note that, similar to the embodiment of FIG. 1, the servo controller 640 controls the spindle motor 604 through a spindle driver 626 as shown in FIG. 6.

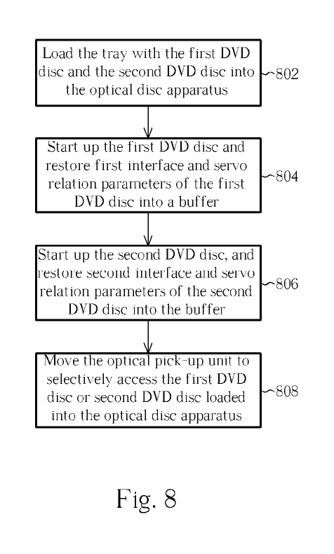

Please refer to FIG. 8. FIG. 8 illustrates a flowchart of a method for operating the optical disc apparatus 600 shown in FIG. 6 according to an embodiment of the present invention. The method comprises the following steps:
Step 802: Load the tray 620 with the first DVD disc 622 and the second DVD disc 624 loaded on the first holding plate 608 and the second holding plate 610 respectively, into the optical disc apparatus 600;
Step 804: Start up the first DVD disc 622 and restore first interface and servo relation parameters of the first DVD disc 622 into a buffer;
Step 806: Start up the second DVD disc 624, and restore second interface and servo relation parameters of the second DVD disc 624 into the buffer; and
Step 808: Move the optical pick-up unit 614 to selectively access the first DVD disc 622 or second DVD disc 624 loaded into the optical disc apparatus 600.

In steps 802 to 806, the method performs a start-up operation for initialization of the optical disc apparatus 600. When the tray 620 moves to carry the first holding plate 608 and second holding plate 610 with the first DVD disc 622 and second DVD disc 624 loaded thereon into the optical disc apparatus 600, the servo controller 640 starts up the first DVD disc 622 and restores the first interface and servo relation parameters corresponding to the first DVD disc 622 into the servo controller 640. Then, the servo controller 640 starts up the second DVD disc 624 and restores the second interface and servo relation parameters corresponding to the second DVD disc 624 into the servo controller 640 to complete the start-up operation.

Similar to the embodiment of FIG. 1, after the initialization, the optical disc apparatus 600 is also allowed to execute a variety of data accessing operations through moving the optical pick-up unit 614 between the first DVD disc 622 and the second DVD disc 624, which is the above-mentioned single-work operation and the multi-work operation. Since the operation of the single-work operation and the multi-work is well known to those skilled in this art after reading the disclosure of the first embodiment in FIG. 1, FIG. 3, and FIG. 5, further description is omitted here for brevity.

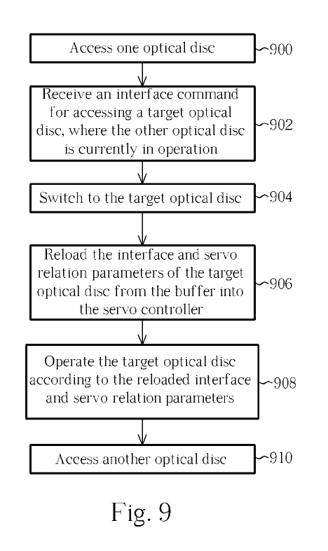

Please refer to FIG. 9. FIG. 9 is a flowchart of the method for switching data access between the first DVD disc 622 and the second DVD disc 624 according to the embodiment shown in FIG. 6. The operation of switching between the first DVD disc 622 and the second DVD disc 624 is summarized as the following steps:
Step 900: Access one optical disc (e.g., the second DVD disc 624);
Step 902: Receive an interface command for accessing a target optical disc (e.g., the first DVD disc 622), where the other optical disc (e.g., the second DVD disc 624) is currently in operation;
Step 904: Switch to the target optical disc (e.g., the first DVD disc 622);
Step 906: Reload the interface and servo relation parameters of the target optical disc (e.g., the first DVD disc 622) from the buffer into the servo controller 640;
Step 908: Operate the target optical disc (e.g., the first DVD disc 622) according to the reloaded interface and servo relation parameters; and
Step 910: Access another optical disc (e.g., the first DVD disc 622).

Please note that, the operation of switching between the first DVD disc 622 and the second DVD disc 624 from the step 900 to step 910 is similar with that corresponding to the step 400 to step 412, therefore the detailed description is omitted here for brevity.

In aforementioned exemplary embodiments, one of the optical discs loaded into the disclosed optical disc apparatus (e.g., the second optical disc) can be implemented by a dual-layer rewritable DVD disc, a DVD-RAM disc, or a dual-layer rewritable Blu-ray (BD) disc for mass storage. Generally speaking, the allowable number of times of directly overwriting the dual-layer rewritable DVD disc is substantially equal to 1000; the allowable number of times of directly overwriting the DVD-RAM disc is greater than 1000; and the allowable number of times of directly overwriting the dual-layer rewritable BD disc is greater than 1000. Therefore, in a specific case where one of the optical discs loaded into the disclosed optical disc apparatus is to act as a permanent storage component (e.g., the loaded dual-layer rewritable DVD disc, the DVD-RAM disc, or the dual-layer rewritable BD disc will not be removed or ejected from the optical disc apparatus), the associated disc parameters, such as optimum power calibration (OPC) data and other calibration data, can be restored into a non-volatile storage (e.g., a flash memory) when manufacturing the disclosed optical disc apparatus. In this way, there is no need to perform the start-up calibration and OPC procedure upon this permanently loaded optical disc. Furthermore, this optical disc can serve as a data buffer like a conventional hard disk drive. For example, regarding the dual-layer rewritable BD disc, it has a data capacity of 50 gigabytes, and can be used to record up to 10.6 (50 GB/4.7 GB) typical DVD movies. Additionally, in an alternative design, a portion of the data recording area on this optical disc can be allocated for certain system applications. For instance, this portion of the data recording area is configured to take place of the conventional EEPROM for storing the OPC history, the auto write strategy (WSR) table, the backup power curve, etc.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical disc apparatus, comprising:
a rotation module for rotating a plurality of optical discs;
a plurality of holding plates, at least comprising a first holding plate and a second holding plate, for loading the optical discs;
a sled guide bar, positioned between the first holding plate and second holding plate on a straight line;
an optical pick-up unit, for accessing the optical discs; and
a sled motor, moveably positioned of sled on the sled guide bar, for loading the optical pick-up unit and driving the optical pick-up unit along the sled guide bar to access each of the optical discs loaded on the holding plates.

2. The optical disc apparatus of claim 1, wherein the rotation module further comprises:
a first spindle motor, for rotating a first optical disc loaded on the first holding plate;
a second spindle motor for rotating a second optical disc loaded on the second holding plate.

3. The optical disc apparatus of claim 2, further comprising:
a servo controller, coupled to the first and second spindle motors, for performing a DMO (Driver Motor Output) Hold operation or open loop DAC operation for the first spindle motor rotating the first optical disc during the sled motor moves the optical pick-up unit from the first optical disc to the second optical disc.

4. The optical disc apparatus of claim 1, wherein the rotation module further comprises:
a first transmission mechanism;
a second transmission mechanism; and
a spindle motor, coupled to the first transmission mechanism and the second transmission mechanism, for rotating the first optical disc and the second optical disc.

5. The optical disc apparatus of claim 4, further comprising:
a servo controller, coupled to the spindle motor, for performing a DMO (Driver Motor Output) Hold operation or open loop DAC operation for the spindle motor rotating the first optical disc during the sled motor moves the optical pick-up unit from the first optical disc to the second optical disc.

6. A method for operating an optical disc apparatus, the method comprising:
starting up a first optical disc, restoring a first interface and servo relation parameters of the first optical disc into a buffer;
performing a DMO (Driver Motor Output) Hold operation or open loop DAC operation for the first optical disc;
starting up a second optical disc;
restoring a second interface and servo relation parameters of the second disc into the buffer; and
performing the DMO Hold operation on a second spindle driver.

7. A method for operating an optical disc apparatus, the method comprising:
receiving an interface command for accessing a first optical disc when accessing the second optical disc;
performing the DMO Hold operation or open loop DAC operation for the second optical disc;
switching to accessing the first optical disk;
reloading a first interface and servo relation parameters of the first optical disc from the buffer, and accessing the first optical disc.
